(19) United States
(12) Patent Application Publication
(10) Pub. No.: US 2012/0145922 A1
(43) Pub. Date: Jun. 14, 2012

(54) CHLOROPHYLL FLUOROMETER AND MEASURING SYSTEM FOR CHLOROPHYLL CONCENTRATION EMPLOYING THE SAME

(75) Inventor: Chungpin Liao, Taichung (TW)

(73) Assignee: INNOT BIOENERGY HOLDING CO., George Town (KY)

(21) Appl. No.: 13/076,235

(22) Filed: Mar. 30, 2011

(30) Foreign Application Priority Data
Dec. 13, 2010 (CN) 201010585551.0

(51) Int. Cl. G01N 21/64

(52) U.S. Cl. 250/458.1

(57) ABSTRACT

An exemplary measuring system for chlorophyll concentration of the present invention includes a chlorophyll fluorometer. The chlorophyll fluorometer includes a temperature sensor and an outer illuminator sensor. The outer illuminator sensor is electrically connected to the temperature sensor.

### CROSS-REFERENCE TO RELATED APPLICATION

This application claims priority of Chinese Patent Application No. 201010585551.0, filed on Dec. 13, 2010, entitled “chlorophyll fluorometer and measuring system for chlorophyll concentration employing the same” by Chungpin Liao, the disclosure of which is incorporated herein by reference in its entirety.

### FIELD OF THE INVENTION

The present invention relates to fluorometer material chlorophyll, and more particularly to a chlorophyll fluorometer and a measuring system for chlorophyll concentration employing the chlorophyll fluorometer.

### BACKGROUND OF THE INVENTION

Photosynthesis is very important to all lives in the natural world, and some energy is released as fluorescent light during a procedure of the photosynthesis. The fluorescent light may protect plants from being burned, and has an inverse relation to a photosynthetic rate of the photosynthesis. Therefore, the photosynthesis could be studied by measuring chlorophyll fluorescent.

What is needed, therefore, is a chlorophyll fluorometer and a measuring system for chlorophyll concentration employing such a chlorophyll fluorometer.

### SUMMARY OF THE INVENTION

The present invention provides a chlorophyll fluorometer and a measuring system for chlorophyll concentration employing such a chlorophyll fluorometer that a chlorophyll quantum yield is optimized. The advantages of the present invention will be understood more readily after a consideration of the drawings and the detailed description of the preferred embodiments.

### BRIEF DESCRIPTION OF THE DRAWINGS

The present invention will become more fully understood from the detailed description given herein below for illustration only, and thus are not limitative of the present invention, and wherein:

FIG. 1 shows a schematic view of a chlorophyll fluorometer according to an exemplary embodiment of the present disclosure;

FIG. 2 shows a result chart of a first experiment employing the chlorophyll fluorometer as shown in FIG. 1;

FIG. 3 shows a result chart of a second experiment employing the chlorophyll fluorometer as shown in FIG. 1;

FIG. 4 shows a result chart of a third experiment employing the chlorophyll fluorometer as shown in FIG. 1; and

FIG. 5 shows a result chart of a fourth experiment employing the chlorophyll fluorometer as shown in FIG. 1.

### DETAILED DESCRIPTION OF THE INVENTION

Reference will now be made to the drawings to describe an exemplary embodiment in detail.

A quantum yield of a chlorophyll has a linear relation to a concentration of the chlorophyll, therefore a chlorophyll fluorometer may be employed for measuring the quantum yield of the chlorophyll and further measuring the concentration of chlorophyll.

A quantum yield of a senior terrestrial plant is about in a range of 0.01 to 0.99. In the illustrated embodiment of the present invention, pluralities of experiments are performed to find a best way for achieving a desired quantum yield of the chlorophyll. In the experiments, the quantum yield of the chlorophyll is preferably in a range of 0.07 to 0.5.

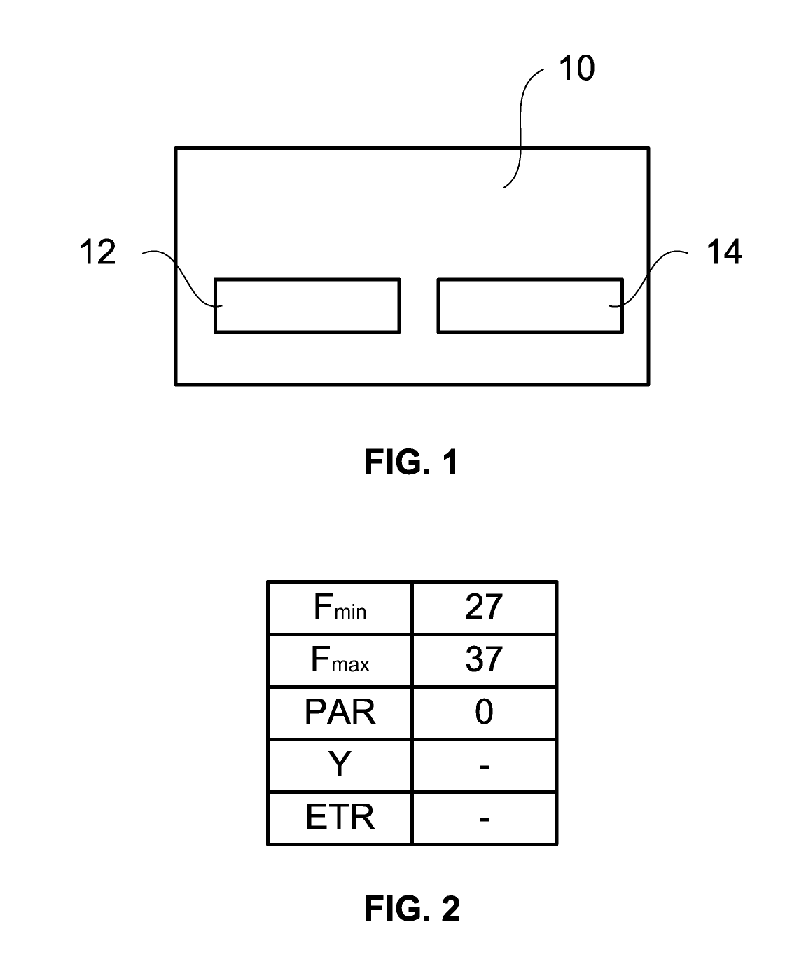

Referring to FIG. 1, a chlorophyll fluorometer according to an exemplary embodiment of the present invention is shown. The chlorophyll fluorometer 10 is capable of measuring an electron transport rate (ETR) inside senior terrestrial plants. The chlorophyll fluorometer 10 includes an illuminator (not shown), a temperature sensor 12, and an outer illuminator sensor 14.

The illuminator is positioned above the temperature sensor 12, and is away from the temperature sensor 12. The illuminator is electrically connected to the temperature sensor 12 and the outer illuminator sensor 14, respectively. The temperature sensor 12 contacts the outer illuminator sensor 14, and is electrically connected with the outer illuminator sensor 14.

With the above described chlorophyll fluorometer 10, the plurality of experiments result in several charts shown in FIGS. 2 to 5. In the charts of FIG. 2 to FIG. 5, “Fₘᵢₙ” represents a minimal fluorescence value, “Fₘₐₓ” represents a maximal fluorescence value, “PAR” represents an effective fluorescence value, “Y” represents a quantum yield, and “ETR” represents an electron transport rate.

In the first experiment, a first dry separator is utilized as a first dry carrier. The first dry separator includes a salt compound absorbed thereon. Referring to FIG. 2, showing the result of the first experiment, “Fₘᵢₙ” is 27, “Fₘₐₓ” is 37, and “PAR” is 0. That is, the first dry separator only having the salt compound absorbed thereon is unsuitable for measuring the chlorophyll quantum yield and the chlorophyll concentration.

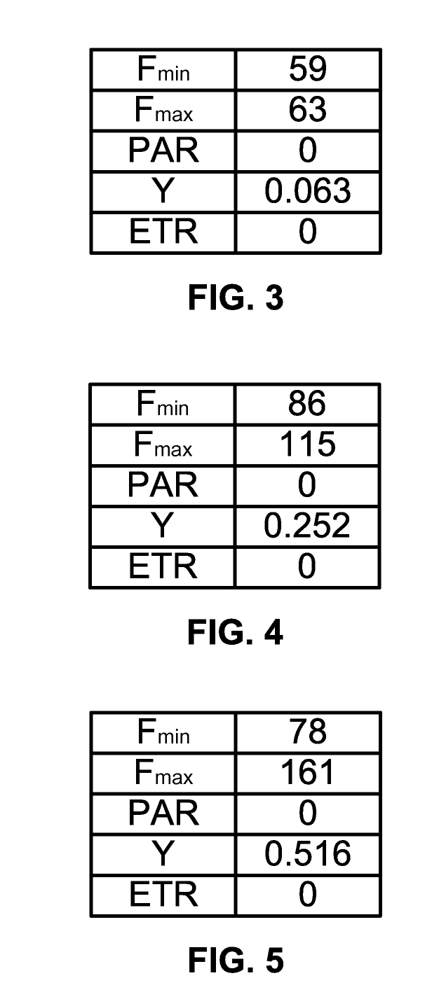

In the second experiment, a second dry separator is utilized as a second dry carrier. The second dry separator includes a salt compound and chlorophyll absorbed thereon. Referring to FIG. 3, showing the result of the second experiment, “Fₘᵢₙ” is 59, “Fₘₐₓ” is 63, “PAR” is 0, “Y” is 0.063, and ETR is 0. That is, the second dry separator only having the salt compound and the chlorophyll absorbed thereon is more suitable for measuring the chlorophyll quantum yield and the chlorophyll concentration than the first dry separator.

In the third experiment, a first wet separator is utilized as a first wet carrier. The first wet separator includes water, a salt compound and chlorophyll absorbed thereon. Referring to FIG. 4, showing the result of the third experiment, “Fₘᵢₙ” is 86, “Fₘₐₓ” is 115, “PAR” is 0, “Y” is 0.252, and ETR is 0. That is, the first wet separator having water, the salt compound and the chlorophyll absorbed thereon is more suitable for measuring the chlorophyll quantum yield and the chlorophyll concentration than the second dry separator.

In the fourth experiment, a second wet separator is utilized as a carrier. The second wet separator includes alcohol, a salt compound and chlorophyll absorbed thereon. A concentration of the chlorophyll absorbed on the second wet separation is relatively high. Referring to FIG. 5, showing the result of the fourth experiment, “Fₘᵢₙ” is 78, “Fₘₐₓ” is 161, “PAR” is 0, “Y” is 0.516, and ETR is 0. That is, the second wet separator having the alcohol, the salt compound and the chlorophyll absorbed thereon is more suitable for measuring chlorophyll the quantum yield and the chlorophyll concentration than the first wet separator.

As is described above, a carrier having the alcohol, the salt compound and the chlorophyll absorbed thereon, the chlorophyll quantum yield is optimized, and the quantum yield may reach 0.516. On the other hand, a fluorescence effect is unavailable for the first dry separation and the second dry separator.

While there has been shown several and alternate embodiments of the present invention, it is to be understood that certain changes can be made as would be known to one skilled in the art without departing from the underlying scope of the present invention as is discussed and set forth above and below including claims. Furthermore, the embodiments described above and claims set forth below are only intended to illustrate the principles of the present invention and are not intended to limit the scope of the present invention to the disclosed elements.

What is claimed is:

1. A chlorophyll fluorometer, comprising:
a. a temperature sensor; and
b. an outer illuminator sensor electrically connected to the temperature sensor.

2. The chlorophyll fluorometer of claim 1, further comprising an illuminator, wherein the illuminator is electrically connected to the outer illuminator sensor.

3. The chlorophyll fluorometer of claim 2, wherein the temperature sensor is further electrically connected to the illuminator.

4. The chlorophyll fluorometer of claim 2, wherein the illuminator is positioned above and away from the temperature sensor.

5. A measuring system for chlorophyll concentration, comprising:
a. a chlorophyll fluorometer having a temperature sensor; and
b. an outer illuminator sensor electrically connected to the temperature sensor.

6. The measuring system for chlorophyll concentration of claim 5, further comprising an illuminator, wherein the illuminator is electrically connected to the outer illuminator sensor.

7. The measuring system for chlorophyll concentration of claim 6, wherein the temperature sensor is further electrically connected to the illuminator.

8. The measuring system for chlorophyll concentration of claim 6, wherein the illuminator is positioned above and away from the temperature sensor.

9. The measuring system for chlorophyll concentration of claim 5, further comprising a carrier.

10. The measuring system for chlorophyll concentration of claim 9, wherein the carrier comprises a dry separator.

11. The measuring system for chlorophyll concentration of claim 10, wherein the carrier comprises a salt compound and chlorophyll absorbed thereon.

12. The measuring system for chlorophyll concentration of claim 9, wherein the carrier comprises a wet separator.

13. The measuring system for chlorophyll concentration of claim 12, wherein the carrier comprises water, a salt compound and chlorophyll absorbed thereon.

14. The measuring system for chlorophyll concentration of claim 12, wherein the carrier comprises alcohol, a salt compound and chlorophyll absorbed thereon.
